(19) United States
(12) Patent Application Publication
(10) Pub. No.: US 2024/0388636 A1
(43) Pub. Date: Nov. 21, 2024

(54) COLOR PALETTE REFERENCE SYSTEM AND METHOD

(71) Applicant: Vicki Marsh, Morgantown, WV (US)

(72) Inventor: Vicki Marsh, Morgantown, WV (US)

(21) Appl. No.: 18/668,902

(22) Filed: May 20, 2024

Related U.S. Application Data
(60) Provisional application No. 63/502,994, filed on May 18, 2023.

(51) Int. Cl. H04L 67/146; G06Q 30/0601; H04L 67/306

(52) U.S. Cl. CPC H04L 67/146; G06Q 30/0641; H04L 67/306

(57) ABSTRACT

A system or method for an online platform for determining a color palette reference system and method for a user using data collected from the user via an online platform for consumers and retailers. The system or method may include a kit for implementation of the color palette system and method and a mobile application for implementation of the color palette system and method. The method and system is an innovative and unique omni-channel shopping tool for personalized color selection, discovery, and authentication of apparel, cosmetics, accessories and home decor.

### CROSS REFERENCE TO RELATED APPLICATIONS

This patent application claims the benefit of and priority to U.S. Provisional Patent Application Ser. No. 63/502,994, “COLOR PALETTE REFERENCE SYSTEM AND METHOD” filed on May 18, 2023, which is hereby incorporated in its entirety.

### BACKGROUND OF THE INVENTION

The application generally relates to a color palette reference system and method. The application relates more specifically to a kit and system to brighten an individual's appearance, illuminate, and amplify personal confidence through accurate color blending. The application further relates more specifically to an online platform and mobile application for implementation of the disclosed system and method.

When the subject brings clothes, accessories, makeup, image, and general style more in line with the person that the subject was meant to be, closet, jewelry, and cosmetics will flow harmoniously, all in complement to the subject's personal color palette. Currently, shopping for clothing, cosmetics, and accessories can be overwhelming and frustrating, with many shoppers unaware of what items best complement their personal features.

What is needed is a system and/or method that satisfies one or more of these needs or provides other advantageous features. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

One embodiment relates to an online platform for determining a color palette reference system and method for a user, and data collected from the online platform for consumers and retailers.

Another embodiment relates to a physical kit for implementation of the color palette system and method.

Another embodiment relates to a mobile application for implementation of the color palette system and method.

Advantages of the method and system include user personalization, discovery, authentication, and registry, and an innovative and unique omni-channel shopping tool for personalized color selection and authentication of apparel, cosmetics, accessories, and home decor.

Another advantage is an online color search and discovery platform and library using artificial intelligence and data science for a personalized shopping experience in-store and online; an online color registry for gifting; and a color influencer for the fashion, beauty, home décor and technology industries.

The disclosed method will also allow people to determine their true, authentic colors for apparel, cosmetics and accessories, while at the same time allowing traditional retailers and e-commerce retailers to provide customized, accurate color selections and recommendations to customers, to enhance revenue and reduce product returns.

Retailers, e-commerce retailers and designers may curate and create highly personalized cosmetic, apparel, accessory and home décor options for their customers to browse, search, and buy.

Authentication and verification of in-store and online product colors can be performed utilizing the claimed invention via a color library of over 500 palette colors.

An online color legend comprising over 500 distinct colors is provided for e-commerce retailer customers to search for very specific colors and their best colors, which gives retailers, brands and designers unprecedented and unparalleled insights to optimize marketing, merchandising and product development.

The claimed invention provides relief from e-Commerce inefficiency, e.g., currently a high (40%) return rate. The disclosed method will reduce that rate significantly in two ways: every color purchase is based on a personalized color collection, so the purchased items are within their own customized and personalized coloring “spectrum;” that particular color purchase is authenticated to know exactly what color they are buying and exactly what the color will look like when received.

A guided selling function includes a process to help potential buyers of products and services choose the right product, best fulfilling their needs and, hopefully, guiding the buyer to buy colors that make them look and feel their absolute best. Personalization is a top priority for retailers. Providing relevant shopping experiences is the ultimate goal for retailers.

In-store associates can greet the subject and recognize him or her. Online stores know shopping habits associated with the subject, but lack the human touch. The disclosed method and system merges in-store and online to create a truly personalized shopping experience. Consumers respond to the personalized store experience as it enhances customer relations. Such an experience boosts sales and allows retailer to make sophisticated recommendations and drive product suggestions. Consumers feel special and feel like the retailer “knows them”. The online platform can suggest and make product color decisions. Online personalization is about the content and data. In-store personalization is about the customer's “journey” and creating an experience that is relevant for the customer as an individual.

Customers and retailers benefit afterwards with marketing initiatives by sending them color-appropriate coded web cookies instead of irrelevant standard web cookies in colors that do not align with the customer's custom color palette.

The disclosed method merges the data-rich universe of online shopping with the high-touch world of traditional brick-and-mortar offering consumers “Color Education” and “Color Influencing” and “Color Tools” using customer color data to create a truly customized omni-channel shopping experiences, online, in-store, on social media, and via mobile applications.

The disclosed system and method says to customers: I know you; I recognize you; I know what you look like (i.e. your hair color, skin undertones and eye colors); I know what colors appear best; I know what your palette colors are; I know what palette colors you buy the most and in what items. The disclosed system and method has authenticated these apparel and cosmetic items, so the subject knows these are verified colors that are unique to the subject. The disclosed system and method will work with retailers to send the subject outfit and makeup suggestions through enhanced web cookies only in the colors of the subject's choice. The disclosed system and method is an innovative, personalized shopping experience that is very unique.

The disclosed system and method allows for educating consumers about color selections, capturing consumer color data, organizing consumer color data for retailers, assisting consumers with powerful and proper color shopping tools, storing consumer color data, influencing consumer buying decisions online and in-store, authenticating product colors online and in-store, matching and introducing consumers and retailers.

The disclosed system and method solutions provide many features and functionalities, including: a kit, in-store retail, online platform, color data, personalized or enhanced cookies, color library, color search engine, color registry.

A consumer purchases the disclosed system and method kit at traditional brick-and-mortar retailers and online, or downloads the mobile application from a mobile application store. The disclosed system and method customer reads the instruction book and follows the associated step-by-step consultation, performs individual color analysis at home and determines their true authentic colors, i.e. their palette colors.

Customers are able to perform their color analysis in the comfort and privacy of their own home. Retailers could also have sales associates offering assistance in-store. The consumer is now armed with new shopping tools in the form of a color profile. They can carry this color profile with them every time they shop for apparel, cosmetics and accessories at traditional brick-and-mortar retailers. Once consumer knows their personalized color palette, they will go to the online platform and complete a questionnaire which includes listing their personalized color profile. Consumer can also use these personalized color shopping tools with online e-commerce retailer partners the offer the color library on their website.

Consumers will have to grant access to the retailer to access their color profile for this “pre-shopping” experience. Access can also be given to friends and family for gift purchases via the registry.

The disclosed system and method may include: a “pop-up” store within the retailer local concept store, so their sales associates can assist their customers with their Twinkle Colors analysis if the customer does not want to do it alone at home. After the analysis and consultation has been completed and the customer knows what their true authentic color palette colors are, that data is keyed into the online color platform database for that particular customer and can be accessed either via the retailer's website or the online platform.

Once discovering their best color options for apparel, cosmetics and accessories by utilizing the kit and reading the book, the customer completes their color profile online, which is a customer questionnaire that captures all of their personalized colors and additional fashion and beauty data.

The disclosed system and method customer has options to complete their color profile: they can go to the online platform, or they can go to one of the retail partner's websites to access the online color library from the proprietary icon next to their color legend. The color profile looks the same regardless of whether the subject completed it using the online platform or any one of the retail partner's websites.

The disclosed system and method color profile customer data collected on the website and from various retailer websites is done so via the online platform, which is a link on the website, or via the mobile application. It is the same link on the retailer's websites. The color profile customer data collected is stored in the online platform. All of this data collected from the website and from the retail and e-tail partner websites is retained and stored in the database, which may be licensed to traditional retailers, e-commerce retailers, clothing designers, cosmetic companies and various brands. This allows customers to broadly shop items in their personalized colors from various outlets.

The online platform will connect online shoppers to online e-commerce retailers so the online shopper can shop for certain items very specifically in their customized colors at various e-commerce retailers. The customers will input their unique, personalized colors data into the online platform database via various websites, including major retailer websites that have both a brick-and-mortar and an online presence, and online-only e-commerce retailers that have no brick-and-mortar store locations. The customer goes to the disclosed system and method online platform and completes a customer profile that includes multiple data points such as: identity and contact information, their personalized colors, and various fashion, style, and beauty color-related questions. Once the customer's above data is collected, it is stored in the database. Retailers and e-commerce retailers are not permitted to store any of the disclosed system and method customer data on their systems.

The disclosed system and method organizes customer color data for the retailer after the consumer purchases the product, performs personalized color analysis, and logs the customer's personalized colors. The disclosed system and method then sends personalized or enhanced web cookies, preserving customer preferences.

The disclosed system and method influence customer searching by allowing consumers to search for and discover items in a specific color when a consumer is doing a broad search for a very specific item in a very specific color. Consumers can browse various retailer's websites that offer that product in that color. Consumer purchasing decisions are a direct result of the color analysis, consultation, methodology, theory, data, suggestions and influences. System authentication of the color gives the consumer peace-of-mind knowing there will be no color surprises with the online photo compared to the color of the item they actually receive in the mail; enhanced web cookies are sent to the consumer from retailers and e-commerce retailers are dictated by the proprietary and protected customer color data. The proprietary color data influences what items retailers are sending to their customers.

All of the data collected from the disclosed system and method in addition to all of the retail partners' information is collected in a database, which is housed on the online platform. This data can be analyzed using traditional data science and artificial intelligence. In addition to the color profile information that is collected within the databases, the following data may also be collected: color searches, item searches, buying patterns, sent cookies, opened cookies, unopened cookies, purchased cookies, in-store purchases, and online purchases.

Recommendations may be sent to the consumers from different retailer partners in one of their personalized colors. The disclosed system and method can color-curate entire outfits for consumers.

Retailers can push very specific and relevant cookies to their online customers based on their authenticated personalized colors, which are stored in the online platform database.

The disclosed system and method color library encompasses three things: a proprietary library of 500 or more distinct color hues and tones; a true to color image of the distinct hue or tone; and data information about the hue or tone, including its proprietary moniker, color category, color family, and contrast level. The proprietary color search engine will allow the consumer to browse their authenticated personalized color palette very specifically.

The online platform can also be integrated with online retailer websites to provide browsing enhancements for online shopping.

The disclosed system and method may also be used for home decorating.

The disclosed system and method can authenticate an online color by cross referencing the color library and then direct consumers to a retailer for browsing and purchasing. For example, if the subject does an internet search of “pink dress,” one would find multiple dresses from multiple retailers that are all authenticated as a specific hue or tone or pink contained in the color library. The subject is then assured that all of the dressed are in exact same color of pink on one that aligned with their personalized color palette.

Specific and authenticated color searches for non-fashion and non-beauty items, such as home décor, upholstery and furnishings, etc., would also be available to users. Particular items a retailer may be featuring in-store and online may also have color authentication on the retailers website or within their store. This gives the consumer peace-of-mind, confidence and knowledge to know exactly what colors they are browsing, considering and purchasing both in-store and online. The disclosed system and method can authenticate color, like a “stamp” of validation and a certification that color is true.

### BRIEF DESCRIPTION OF THE DRAWINGS

The application will become more fully understood from the following detailed description, taken in conjunction with the accompanying figures, wherein like reference numerals refer to like elements, in which:

FIG. 1A and FIG. 1B show a flow diagram of the method steps for using the disclosed color palette reference system.

FIG. 2 shows a box containing color petals for use with the color palette method.

FIG. 3 shows an exemplary color petal.

FIG. 4 shows a color ring for attaching color petals for a color palette system.

FIG. 5 shows a pouch for holding the color ring shown in FIG. 4

FIG. 6 shows a flow diagram of the method steps for an embodiment of using the disclosed color palette reference system.

### DETAILED DESCRIPTION OF THE INVENTION

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

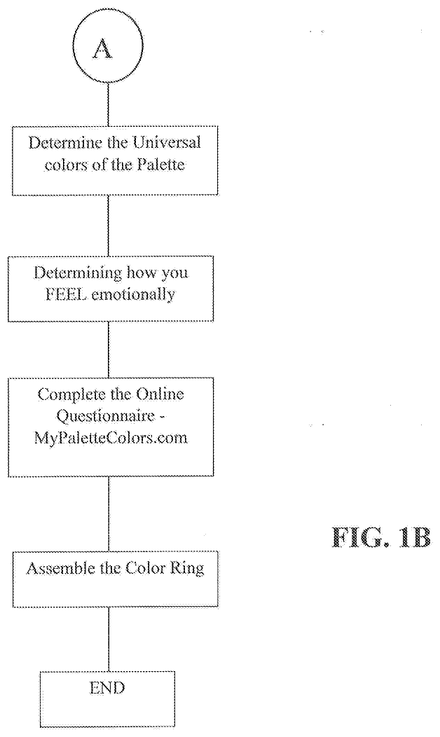

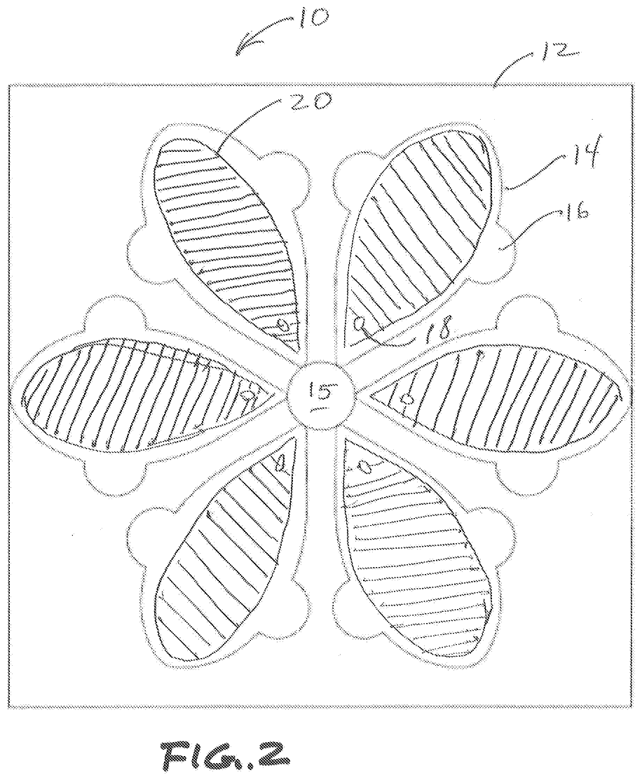

Referring first to FIGS. 2 through 5, a system for a color palette selection method is shown. A box 10 includes a molded form 12 for receiving multiple stacks of color petals 20. The molded form 12 includes hollow receptacles 14 for receiving color petals 20. Each receptacle 14 may be deep enough to contain up to 50 color petals, or more or less depending on the number of colors in the selection. Receptacles 14 are contoured to receive folium-shaped petals. In an embodiment, sic receptacles 14 are projecting radially from a central point 15. Scallops 16 are formed along opposing sides of each receptacle 20 for accessing the petals 20 for removal and insertion with fingers. An aperture 18 is provided adjacent one end of each petal 20.

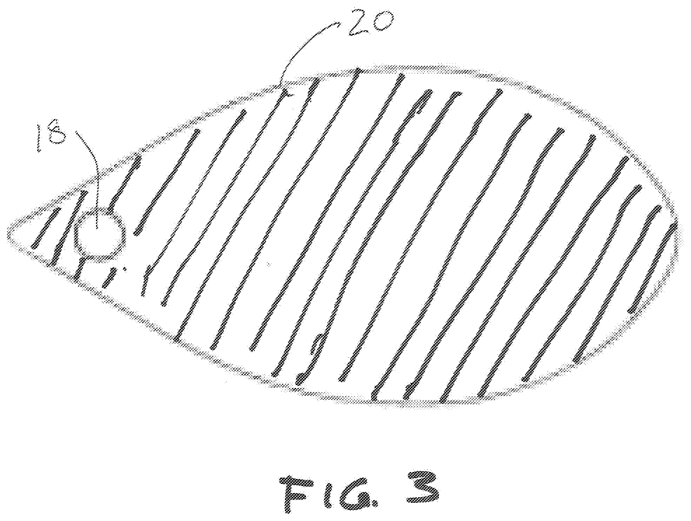

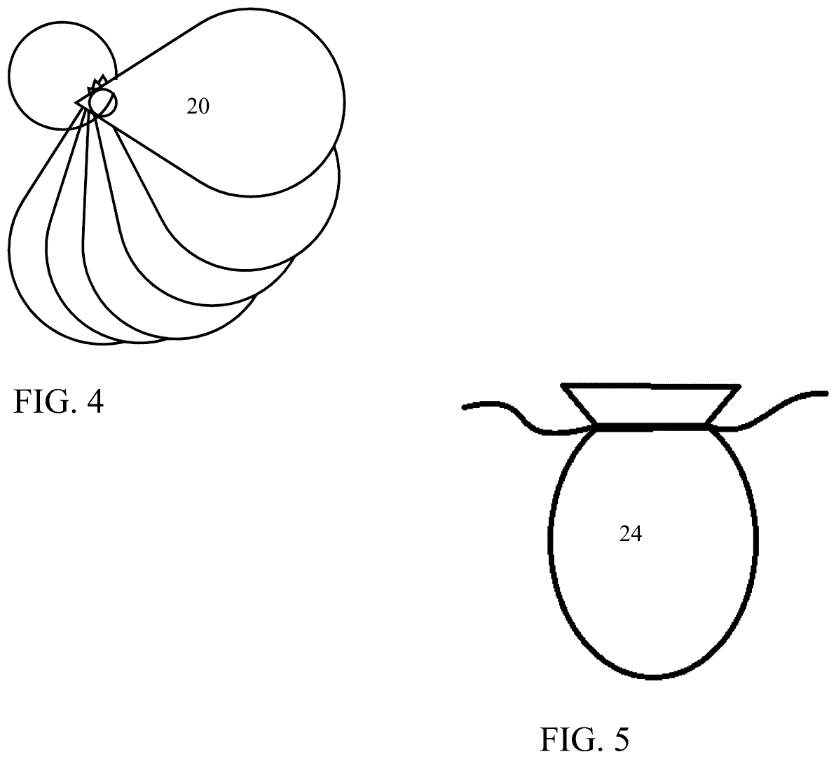

As shown in FIG. 4, a ring 22 is insertable through one or multiple petals 20 for portability of a selected number of petals 20 representing a person's color palette, e.g., to take along with them when shopping, as set forth in greater detail below. FIG. 5 shows a pouch 24 for carrying ring 22 and petals 20.

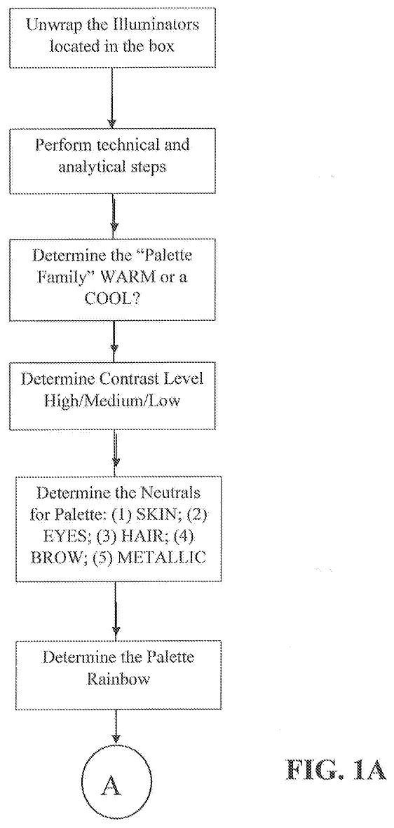

Turning to FIG. 1A and FIG. 1B, the method for determining a personal color palette reference is described as follows: (1) unwrap and set up the box contents, including color palette samples in various categories, such as “warm” or “cool;” (2) perform the technical and analytical steps to determine a personalized color profile, starting with using the red, tan/taupe/brown, and gray samples to determine a “warm” or “cool” classification by comparing them to one's natural skin tone; (3) based on variance of skin and hair colors and using system data, determine a personal contrast level of high, medium, or low; (4) determine a personalized neutral palette by analyzing skin color and tone, eye color, hair color, brow color, and metallic compliments using the system's neutral color samples and compiling a preliminary color profile; (5) determine a personalized bright color palette using the system's color samples in categories already determined, such as “warm/cool,” contrast level, and personalized neutrals; (6) determine a personalized universal color palette using the system's color samples in categories already determined, such as “warm/cool,” contrast level, and personalized neutrals; (7) using the samples so far compiled in the process, perform a subjective analysis to finalize the color palette by gauging emotional and energetic response to the selected colors and by considering one's personal style preferences; (8) complete a system provided proprietary questionnaire to further define the color profile and inform system recommendations; and (9) compile final color profile choices into a personalized color palette reference system in a fixed place for storage and reference, wherein the fixation means may be a metal ring and the storage means may be an appropriately sized portable pouch.

In alternative embodiments, the process described in the preceding paragraph may be formed through an online platform wherein the fixation and storage means are machine readable media.

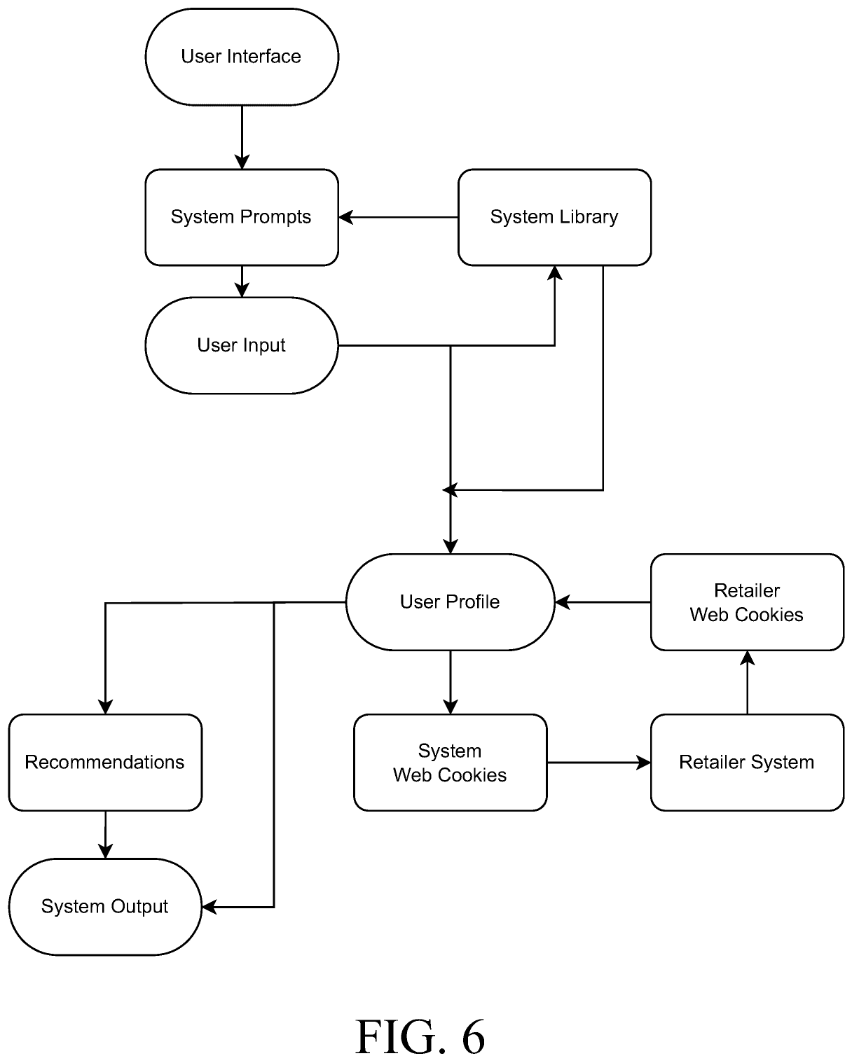

Turning to FIG. 6, a flow chart showing an embodiment of the disclosed system and method is provided and describes the following: a user interface capable of receiving a user and guiding the user to the system; system prompts which guide a user through the system described in FIG. 1A and FIG. 1B; user input to the prompts, which is analyzed by the system with the system data to further inform the prompts and elicit meaningful user responses; a system library which comprises a color library and data pertaining to the method described herein; a user profile determined by the analysis of the user input with the system data after completing all system prompts; system web cookies that comprise portions of the user profile, which may be transmitted to a retail partner; a retailer system, which may be an online or in-store retailer of various goods and merchandise; retailer web cookies, which are informed by such retailer's inventory that may match or compliment the user profile; recommendations determined by the system that match the user profile and may be further informed by the user input responses to personal style and personality prompts; and a system output, which contains the user profile and the recommendations.

An embodiment of the above described method may be implemented using a proprietary algorithm. The same or another embodiment may have a user interface that is an online platform accessible via the internet. The same or another embodiment may have an online platform that is a mobile application. Such an embodiment described herein may be accessible by a user via a personal internet connected device, which may be a mobile smartphone.

Preliminarily, a “warm” or a “cool” distinction is based on hair color, skin undertones, and eye colors and will be the basis for determining all palette colors to follow. Contrast has to do with the contrast between your skin and hair color, and is also important in determining the vastness/variety of the palette colors. Neutrals will be the foundation of the entire color palette, and as everyone's neutrals are different, and are determined by: eye colors, skin color, hair color, and brow color; brown undertones; gray undertones; white undertones; and metallic undertones. The palette rainbow, or bright color palette determines which colors within the families of red, orange, yellow, green, blue, indigo, and violet compliment a user best. The palette universal colors are certain colors everyone can wear and they differ only in the “warm” or “wool” shades that compliment a user best.

User inputted data may include photographs of the subject in various light levels and types.

As the subject experiments with the system and the color library, the subject will need to keep in mind that the process does not determine the subject's favorite colors, but rather the colors that complement their personal color profile the best.

One embodiment of the disclosed system and method comprises a physical kit for a subject to use at home. The kit contains: a plastic tray custom-made in the disclosed system and flocked with white “suede,” having six receptacles to hold the over 500 color samples, thumb and index finger slots to pull out the color samples easily, a metal ring to bind the final personalized color palette reference system, and a carrying case in a custom shape, which may be a pouch in a pink leatherette, a book containing the system instructions and system data, and the color library, comprising samples, of which there may be 500 or more, which may be printed on durable material or enclosed in a protective casing.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

The present application contemplates methods, systems and program products on any machine-readable media for accomplishing its operations. The embodiments of the present application may be implemented using an existing computer processor, or by a special purpose computer processor for an appropriate system, incorporated for this or another purpose or by a hardwired system.

It is important to note that the construction and arrangement of the color palette system and method as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application,

As noted above, embodiments within the scope of the present application include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general-purpose computer, special purpose computer, or special purpose processing machines to perform a certain function or group of functions.

It should be noted that although the figures herein may show a specific order of method steps, it is understood that the order of these steps may differ from what is depicted. Also, two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule-based logic and other logic to accomplish the various connection steps, processing steps, comparison steps and decision steps.

I claim all patentable subject matter disclosed herein:

1. A color palette reference system and method, comprising:
collecting user inputted personalized appearance and personality data through a series of prompts;
analyzing said data with system data to calculate a personalized user profile containing a personalized color palette;
creating an output comprising the personalized user profile and recommendations to the user based upon the personalized user profile.

2. The color palette reference system and method of claim 1 wherein the steps are performed by an algorithm.

3. The color palette reference system and method of claim 2, further comprising the user accessing the system through an interface available via the internet on an internet connected computation device.

4. The color palette reference system and method of claim 3, wherein the interface available via the internet is a mobile application.

5. The color palette reference system and method of claim 1, wherein the personalized appearance and personality data comprises the user's hair color, skin tone, eye color, brow color, and contrast level.

6. The color palette reference system and method of claim 1, wherein the system data comprises a color library.

7. The color palette reference system and method of claim 1, wherein the outputted recommendations comprise personalized style, beauty, and decoration suggestions.

8. The color palette reference system and method of claim 3, further comprising creating personalized web cookies containing portions of the personalized user profile.

9. The color palette reference system and method of claim 8, further comprising transmitting the cookies to the user and retailers related to the recommendations.

10. The color palette reference system and method of claim 9, further comprising receiving web cookies containing merchandise data from the retailers and incorporating the merchandise data into the output.

11. A color palette reference system and method, comprising:
interfacing with a user via an internet-accessible platform;
receiving user inputted personalized appearance and personality data through a series of prompts;
analyzing said data with a system-stored data library;
generating a personalized user profile containing a personalized color palette; and
generating an output comprising the personalized user profile.

12. The color palette reference system and method of claim 11, wherein the output is further comprised of recommendations based on the personalized user profile and personalized color palette.

13. The color palette reference system and method of claim 11, further comprising:
creating personalized web cookies containing portions of the personalized user profile;
transmitting the cookies to the user and recommended retailers;
receiving web cookies containing merchandise data from the retailers; and
incorporating the merchandise data into the output.

14. The color palette reference system and method of claim 11, wherein the internet-accessible platform is a mobile application.

15. The color palette reference system and method of claim 11, wherein the personalized appearance and personality data comprises the user's hair color, skin tone, eye color, brow color, and contrast level.

16. The color palette reference system and method of claim 11, wherein the system-stored data library is comprised of a color library containing a plurality of color hues and tones.

17. A color palette reference system and method, comprising:
instructing a user through a series of prompts related to the user's appearance and personality;
instructing the user to use a plurality of color palette samples in various shades and tones to determine a personalized user color profile based on the prompt responses;
compiling a plurality of color palette samples matching the personalized user color profile into a personalized color palette reference;
providing the personalized color palette reference to the user in a portable container.

18. The color palette reference system and method of claim 17, wherein the prompts solicit the user's hair color, skin tone, eye color, brow color, and contrast level.

19. The color palette reference system and method of claim 17:
wherein the color palette reference system and method comprises a tangible kit, said kit having a box containing an instruction book and a plurality of receptacles, each receptacle capable of receiving a plurality of color palette samples; and
wherein the personalized color palette reference comprises a selection of the color palette samples determined by the responses, said personalized color palette reference being bound and accompanied by a portable storage unit.

20. The color palette reference system and method of claim 19, wherein the color palette samples are folium-shaped petals and the receptacles are contoured to receive said folium-shaped petal color palette samples.
